(19) United States
(12) Patent Application Publication
(10) Pub. No.: US 2020/0013105 A1
(43) Pub. Date: Jan. 9, 2020

(54) INFORMATION PROCESSING SYSTEM AND INFORMATION PROCESSING METHOD

(71) Applicant: NEC Corporation, Minato-ku, Tokyo (JP)

(72) Inventors: Akio KAWACHI, Tokyo (JP); Dai YAMAZAKI, Tokyo (JP)

(73) Assignee: NEC Corporation, Minato-ku, Tokyo (JP)

(21) Appl. No.: 16/483,086

(22) PCT Filed: Jan. 18, 2018
(86) PCT No.: PCT/JP2018/001308

§ 371 Date: Aug. 2, 2019

(30) Foreign Application Priority Data
Feb. 14, 2017 (JP) 2017-024784

(51) Int. Cl. G06Q 30/06; G06N 5/04

(52) U.S. Cl. CPC G06Q 30/0631; G06Q 30/0633; G06N 5/04

(57) ABSTRACT

An information processing system according to the present disclosure includes: a recommendation table for storing a purchase product, recommended products related to the purchase product, and product areas to which the recommended products belong; a purchased product target table for storing a purchased product purchased by a customer; an exclusion area target table for storing an area where the customer has stayed for more than a predetermined staying time as an exclusion area; and an extraction unit that extracts the recommended products related to the purchased product as recommended products for the customer by referring to the purchased product target table and the recommendation table and extracts recommended products for distribution by referring to the recommendation table and the exclusion area target table and excluding a recommended product that belongs to the product area that matches the exclusion area from the recommended products for the customer.

### TECHNICAL FIELD

The present disclosure relates to an information processing system and an information processing method, and relates to, for example, an information processing system and an information processing method for recommending products to a customer.

### BACKGROUND ART

Techniques for recommending products to customers in shops have been known. Patent Literature 1 discloses a technique of creating purchase data of a customer, creating a flow line of the customer, obtaining movement data from the flow line, and sending action pattern data analyzed from past movement data, purchase data including purchasing power analyzed in view of the past purchase data and the like to a mobile terminal of a shop staff member. By using the technique disclosed in Patent Literature 1, the shop staff member is able to select products to be recommended to the customer from the received data.

### CITATION LIST

### Patent Literature

[Patent Literature 1] Japanese Unexamined Patent Application Publication No. 2003-263641

### SUMMARY OF INVENTION

### Technical Problem

Patent Literature 1 does not disclose, however, a specific method regarding how to select products to be recommended from the action pattern data and the purchase data. Therefore, there is a problem in the technique disclosed in Patent Literature 1 that the customer cannot be notified of, after making a payment, only those recommended products that the customer was not aware of at the time of making the payment.

The present disclosure has been made in order to solve the aforementioned problem and aims to provide an information processing system and an information processing method capable of notifying, after making a payment, a customer of only those recommended products that the customer was not aware of at the time of making the payment.

### Solution to Problem

An information processing system according to a first aspect of the present disclosure includes: a recommendation table configured to store a purchase product, products to be recommended in view of the purchase product, and product areas to which the recommendation products belong; a purchased product target table configured to store a purchased product purchased by a customer targeted for a recommendation; an exclusion area target table configured to store an area where the customer targeted for a recommendation has stayed for more than a predetermined staying time as an exclusion area; and extraction means for extracting the products to be recommended in view of the purchased product as products to be recommended for the customer by referring to the purchased product target table and the recommendation table and extracting products to be recommended for distribution by referring to the recommendation table and the exclusion area target table and excluding a recommendation product that belongs to the product area that matches the exclusion area from the products to be recommended for the customer.

An information processing method according to a second aspect of the present disclosure includes: extracting a purchased product purchased by a customer targeted for a recommendation from a purchased product target table configured to store the purchased product; extracting products to be recommended in view of the purchased product as products to be recommended for the customer by referring to a recommendation table configured to store a combination of the purchase product, products to be recommended in view of the purchase product, and product areas to which the recommendation products belong; extracting an exclusion area from an exclusion area target table configured to store an area where the customer targeted for a recommendation has stayed for more than a predetermined staying time as the exclusion area; extracting the product area that matches the exclusion area by referring to the recommendation table; and extracting products to be recommended for distribution by excluding a recommendation product that belongs to a product area that matches the exclusion area from the products to be recommended for the customer.

### Advantageous Effects of Invention

According to the present disclosure, it is possible to provide an information processing system and an information processing method capable of notifying, after making a payment, a customer of only those recommended products that the customer was not aware of at the time of making the payment.

### BRIEF DESCRIPTION OF DRAWINGS

FIG. 1 is a block diagram showing a configuration example of an information processing system according to a first example embodiment of the present disclosure;

FIG. 2 is a flowchart showing a process example of the information processing system according to the first example embodiment of the present disclosure;

FIG. 3 is a block diagram showing a configuration example of an information processing system according to a second example embodiment of the present disclosure;

FIG. 4 is a diagram showing a specific example of a purchase history table according to the second example embodiment of the present disclosure;

FIG. 5 is a diagram showing a specific example of a recommendation table according to the second example embodiment of the present disclosure;

FIG. 6 is a diagram showing a specific example of a flow line history table according to the second example embodiment of the present disclosure;

FIG. 7 is a diagram showing a specific example of an exclusion area target table according to the second example embodiment of the present disclosure;

FIG. 8 is a diagram showing a specific example of a purchased product target table according to the second example embodiment of the present disclosure;

FIG. 9 is a diagram showing a specific example of a distribution target product table according to the second example embodiment of the present disclosure;

FIG. 10 is a diagram showing a specific example of a product information master table according to the second example embodiment of the present disclosure;

FIG. 11 is a diagram showing a specific example of distribution information to be distributed to a distribution destination according to the second example embodiment of the present disclosure;

FIG. 12 is a flowchart showing an example of recommendation table generation processing of the information processing system according to the second example embodiment of the present disclosure;

FIG. 13 is a flowchart showing an example of recommendation product distribution processing of the information processing system according to the second example embodiment of the present disclosure; and

FIG. 14 is a block diagram showing a configuration example of an information processing system according to a third example embodiment of the present disclosure.

### DESCRIPTION OF EMBODIMENTS

Hereinafter, with reference to the drawings, example embodiments of the present disclosure will be described in detail. Throughout the drawings, the same or corresponding elements are denoted by the same reference signs, and repetitive descriptions will be avoided as necessary for clarity of explanation.

### First Example Embodiment

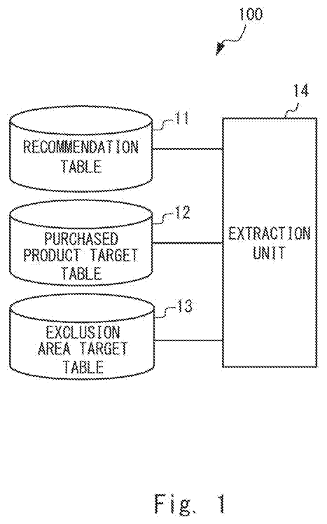

Referring first to a block diagram shown in FIG. 1, a configuration example of an information processing system 100 according to a first example embodiment of the present disclosure will be explained. The information processing system 100 according to the first example embodiment includes a recommendation table 11, a purchased product target table 12, an exclusion area target table 13, and an extraction unit 14.

The recommendation table 11 is a table that stores purchase products, products to be recommended in view of the purchase products, and product areas to which the recommendation products belong.

The recommendation products are products that tend to be purchased by the customer who has purchased the purchase products. The purchase products in the recommendation table 11 may be referred to as prerequisite purchase products since the purchase products are a prerequisite for the recommendation products. The combination of the prerequisite purchase products with the recommendation products is generated, for example, based on purchase history data. That is, the recommendation table 11 can be created based on the purchase history data.

The product area indicates an area in a shop in which a product is arranged. When, for example, the product is sliced bread, the product area is a bread area. When the product is cigarettes, the product area is a cash register area.

The purchased product target table 12 is a table for storing purchased products purchased by the customer targeted for a recommendation.

The exclusion area target table 13 is a table that stores areas where the customer targeted for a recommendation has stayed for more than a predetermined staying time as exclusion areas. The predetermined staying time can be set to, for example, five seconds. The exclusion area can be regarded to be a product area already viewed by the customer targeted for a recommendation at the payment date since the exclusion area is an area where the customer targeted for a recommendation has stayed for more than the predetermined staying time.

The extraction unit 14 refers to the purchased product target table 12 and the recommendation table 11 and extracts the products to be recommended in view of the purchased products as products to be recommended for the customer. More specifically, the extraction unit 14 extracts purchased products purchased by the customer targeted for a recommendation from the purchased product target table 12. Next, the extraction unit 14 refers to the recommendation table 11 and extracts products to be recommended in view of the extracted purchased products as the products to be recommended for the customer. The products to be recommended for the customer are products that tend to be purchased by a customer who has purchased the purchased product.

Further, the extraction unit 14 refers to the recommendation table 11 and the exclusion area target table 13 and extracts products to be recommended for distribution by excluding the recommendation products that belong to the product areas that match the exclusion areas from the products to be recommended for the customer. More specifically, the extraction unit 14 extracts the exclusion areas from the exclusion area target table 13. Further, the extraction unit 14 refers to the recommendation table 11 and extracts the product areas that match the extracted exclusion areas. Next, the extraction unit 14 extracts the products to be recommended for distribution by excluding the recommendation products that belong to the product areas that match the exclusion areas from the products to be recommended for the customer.

The customer has stayed in the product area that matches the exclusion area for more than the predetermined staying time. Therefore, it can be said that the recommendation products that belong to the product areas that match the exclusion areas are products that the customer has already considered whether to purchase or not.

Further, the products to be recommended for distribution are products obtained by excluding the recommendation products that belong to the product areas that match the exclusion areas from the products to be recommended for the customer. Therefore, it can be regarded that the products to be recommended for distribution are recommendation products obtained by excluding products already viewed by the customer from the products to be recommended for the customer. That is, it can be said that the products to be recommended for distribution are the ones extracted from areas in which the customer targeted for a recommendation has not stayed at the payment date such as areas this customer passed by without stopping or areas the same customer has not passed among the products to be recommended for the customer.

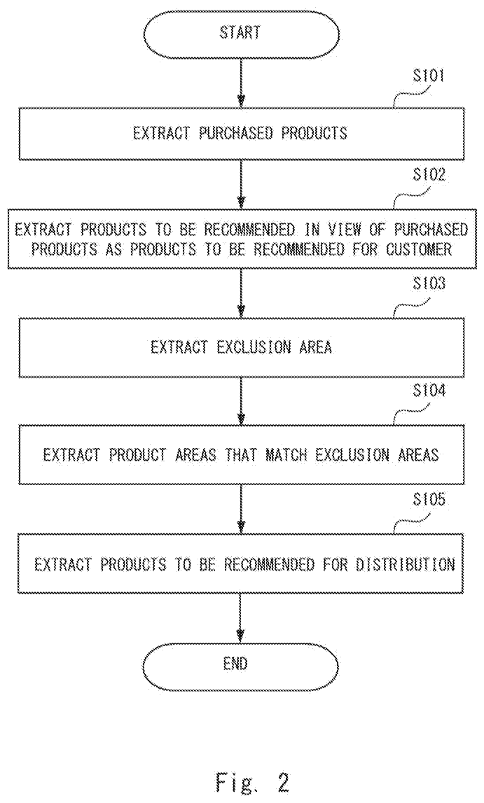

Referring next to a flowchart shown in FIG. 2, a process example of the information processing system 100 will be explained.

First, the extraction unit 14 extracts the purchased products purchased by the customer targeted for a recommendation from the purchased product target table 12 (Step S101).

Next, the extraction unit 14 refers to the recommendation table 11 and extracts products to be recommended in view of the extracted purchased products as the products to be recommended for the customer (Step S102).

Next, the extraction unit 14 extracts the exclusion areas from the exclusion area target table 13 (Step S103).

Next, the extraction unit 14 refers to the recommendation table 11 and extracts the product areas that match the extracted exclusion areas (Step S104).

Next, the extraction unit 14 extracts the products to be recommended for distribution by excluding the recommendation products that belong to the product areas that match the exclusion areas from the products to be recommended for the customer (Step S105).

As described above, in the information processing system 100 according to the first example embodiment of the present disclosure, the extraction unit 14 is configured to extract the products to be recommended in view of the purchased products as the products to be recommended for the customer by referring to the purchased product target table 12 and the recommendation table 11. Further, in the information processing system 100, the extraction unit 14 is configured to extract products to be recommended for distribution by excluding the recommendation products that belong to the product areas that match the exclusion areas from the products to be recommended for the customer by referring to the recommendation table 11 and the exclusion area target table 13. Accordingly, the information processing system 100 is able to extract the products in the areas in which the customer targeted for a recommendation has not stayed on the payment date as the products to be recommended for distribution from among the products to be recommended for the customer. That is, in the information processing system 100, by using the extracted products to be recommended for distribution, it is possible to notify, after making a payment, the customer of only those recommended products that the customer was not aware of at the time of making the payment.

### Second Example Embodiment

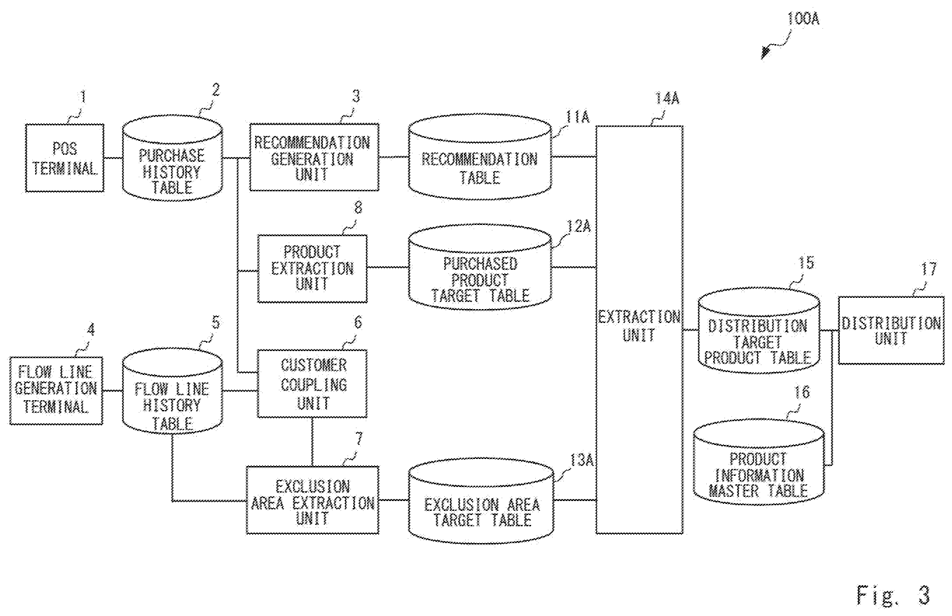

With reference next to a block diagram shown in FIG. 3, a configuration example of an information processing system 100A according to a second example embodiment of the present disclosure will be explained. The information processing system 100A according to the second example embodiment of the present disclosure is a specific example of the information processing system 100 according to the first example embodiment. The information processing system 100A according to the second example embodiment includes a Point Of Sales (POS) terminal 1, a purchase history table 2, a recommendation generation unit 3, a flow line generation terminal 4, a flow line history table 5, a customer coupling unit 6, an exclusion area extraction unit 7, a product extraction unit 8, a recommendation table 11A, a purchased product target table 12A, an exclusion area target table 13A, an extraction unit 14A, a distribution target product table 15, a product information master table 16, and a distribution unit 17.

The POS terminal 1 is a payment terminal for registering payment information when a product has been purchased. The POS terminal 1 stores scanned payment information in the purchase history table 2.

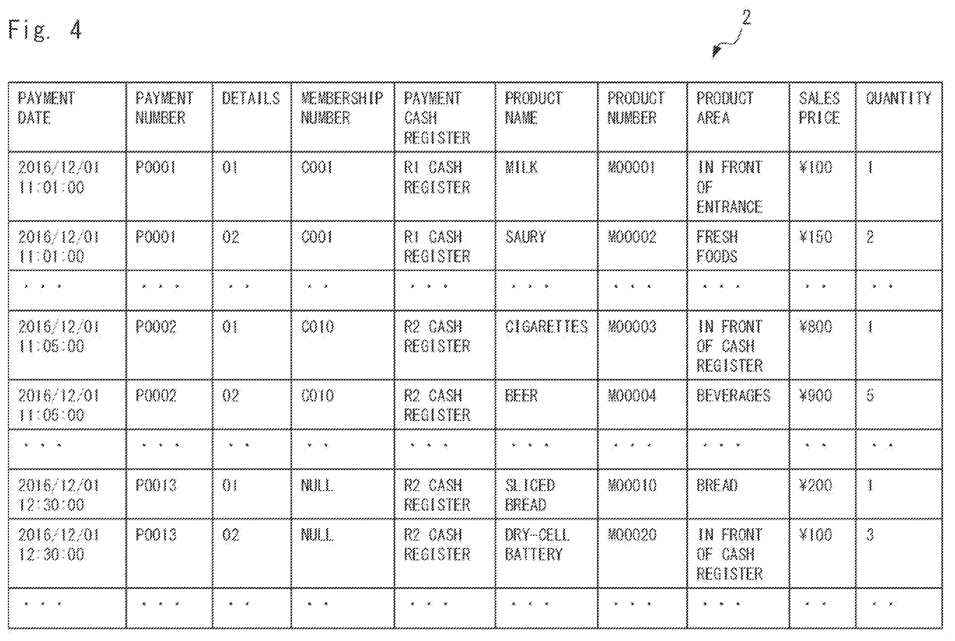

With reference now to FIG. 4, a specific example of the purchase history table 2 will be explained. In the example shown in FIG. 4, the purchase history table 2 stores a payment date, a payment number, details, a membership number, a payment cash register, a product name, a product number, a product area, a sales price, and a quantity.

The purchase history table 2 stores that payment by the customer whose membership number is C001 has been registered in an R1 cash register as payment of a payment number P0001 at 11:01:00 on Dec. 1, 2016. In P0001, details of milk that belongs to a product area in front of the entrance, the product number thereof being M00001, are registered as details 01. The sales price ¥100 and the quantity 1 of milk are also registered. Further, details of saury that belongs to a product area of fresh foods, the product number thereof being M00002, are registered as details 02 of P0001. The sales price ¥150 and the quantity 2 of saury are also registered.

The purchase history table 2 further stores that payment by the customer whose membership number is C010 has been registered in an R2 cash register as payment of a payment number P0002 at 11:05:00 on Dec. 1, 2016. In P0002, details of cigarettes that belong to a product area in front of the cash register, the product number being M00003, are registered as details 01. The sales price ¥800 and the quantity 1 of the cigarettes are also registered. Further, details of beer that belongs to a product area of beverages, the product number thereof being M00004, are registered as details 02 of P0002. The sales price ¥900 and the quantity 5 of the beer are also registered.

The purchase history table 2 further stores that payment by the customer whose membership number is NULL is registered in the R2 cash register as payment of a payment number P0013 at 12:30:00 on Dec. 1, 2016. The customer whose membership number is NULL indicates the customer who has no membership number. In P0013, details of sliced bread that belongs to a product area of bread, the product number thereof being M00010, are registered as details 01. The sales price ¥200 and the quantity 1 of the sliced bread are also registered therein. Further, details of a dry-cell battery that belongs to a product area in front of the cash register, the product number thereof being M00020, are registered as details 02 of P0013. The sales price ¥100 and the quantity 3 of the dry-cell battery are also registered therein.

Referring once again to FIG. 3, descriptions will be continued. The recommendation generation unit 3 calculates the priority of the recommendation for each of combination of the products included in the purchase history table 2. Further, the recommendation generation unit 3 stores a combination of the products in the recommendation table 11A as the prerequisite purchase product and products to be recommended in view of the prerequisite purchase product. Further, the recommendation generation unit 3 stores the prerequisite purchase products and the priority of the products to be recommended in view of the prerequisite purchase product in the recommendation table 11A. Further, the recommendation generation unit 3 stores the product areas to which the recommendation products belong in the recommendation table 11A.

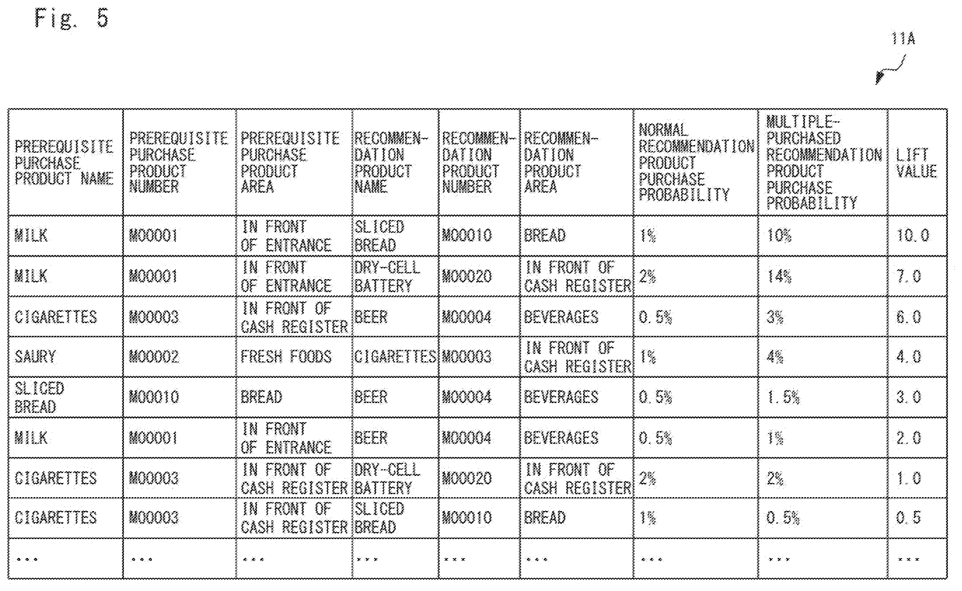

With reference now to FIG. 5, a specific example of the recommendation table 11A will be explained. In the example shown in FIG. 5, the recommendation table 11A stores a prerequisite purchase product name, a prerequisite purchase product number, a prerequisite purchase product area, a recommendation product name, a recommendation product number, a recommendation product area, a normal recommendation product purchase probability, a multiple-purchased recommendation product purchase probability, and a lift value. The lift value is one example of the priority.

The normal recommendation product purchase probability is a probability obtained by dividing the number of payments in which the recommendation product exists in the purchase history table 2 by all the number of payments in the purchase history table 2.

The multiple-purchased recommendation product purchase probability is obtained by dividing the number of payments in which both the prerequisite purchase product and the recommendation product exist by the number of payments in which a prerequisite purchase product exists.

The lift value is obtained by dividing the multiple-purchased recommendation product purchase probability by the normal recommendation product purchase probability.

Regarding the information stored in the recommendation table 11A, information indicating that the prerequisite purchase product is milk will be explained. The recommendation table 11A stores sliced bread, a dry-cell battery, and beer as the recommendation products when the prerequisite purchase product is milk. The normal recommendation product purchase probability of the sliced bread is 1%. Further, the normal recommendation product purchase probability of the dry-cell battery is 2%. Further, the normal recommendation product purchase probability of the beer 0.5%.

The recommendation table 11A stores 10% as the multiple-purchased recommendation product purchase probability of sliced bread with milk. The recommendation table 11A further stores 14% as the multiple-purchased recommendation product purchase probability of a dry-cell battery with milk. The recommendation table 11A further stores 1% as the multiple-purchased recommendation product purchase probability of beer with milk.

The recommendation table 11A stores 10.0 as a lift value of sliced bread with respect to milk, 7.0 as a lift value of a dry-cell battery with respect to milk, and 2.0 as a lift value of beer with respect to milk. As shown in the example of FIG. 5, the recommendation table 11A may be sorted in a descending order of the lift values. By sorting the recommendation table 11A in a descending order of the lift values in the recommendation table 11A, it is possible to obtain a table that is suitable for real-time processing.

While the recommendation table 11A calculates the lift value as the priority in the example shown in FIG. 5, other recommendation rules such as sales amount ranking, sales quantity ranking, or arbitrary campaign rules may instead be calculated as the priority.

Referring once again to FIG. 3, descriptions will be continued. The flow line generation terminal 4 is a terminal for generating flow line history of the customer. The flow line generation terminal 4 is, for example, a terminal or the like that collects footprint information from cameras that are installed in several places in a shop, or a mobile terminal owned by the customer. The flow line generation terminal 4 stores the flow line history of a customer in the flow line history table 5.

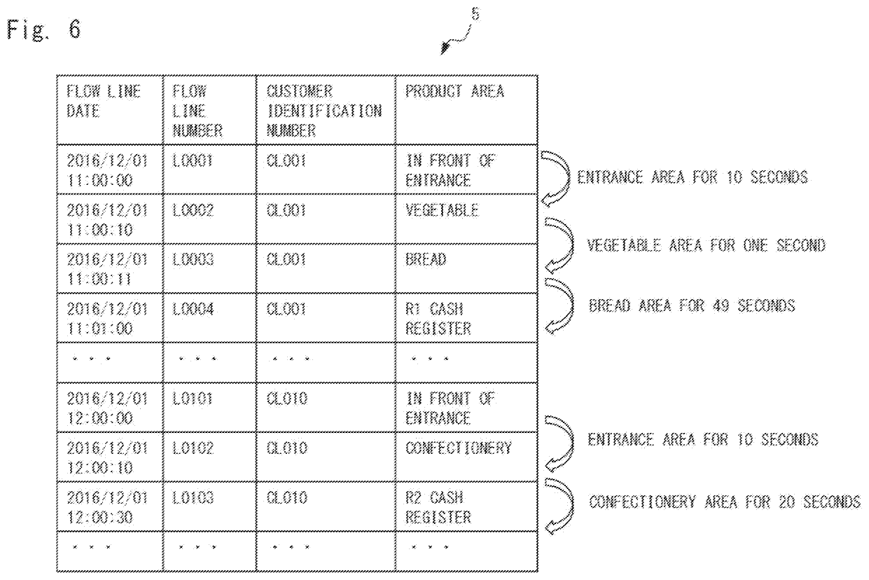

With reference now to FIG. 6, a specific example of the flow line history table 5 will be explained. In the example shown in FIG. 6, the flow line history table 5 stores a flow line date, a flow line number, a customer identification number, and a product area as the flow line history.

The flow line history table 5 stores, as the flow line history of the customer whose customer identification number is CL001, the entrance area at 11:00:00 on Dec. 1, 2016, the vegetable area at 11:00:10, the bread area at 11:00:11, and the R1 cash register at 11:01:00. That is, by referring to the flow line history table 5, it can be calculated that the customer of CL001 has stayed in the entrance area for 10 seconds, stayed in the vegetable area for one second, and stayed in the bread area for 49 seconds.

In a similar way, by referring to the flow line history table 5, it can be calculated that the customer of CL010 has stayed in the entrance area for 10 seconds and has stayed in the confectionery area for 20 seconds.

Referring once again to FIG. 3, descriptions will be continued. The customer coupling unit 6 is a function unit that couples the customer in the purchase history table 2 and the customer in the flow line history table 5 based on the time at which the customer has stayed in the cash register area. The customer coupling unit 6 refers to the purchase history table 2 and the flow line history table 5 and specifies the customer identification number of the customer who has stayed in the corresponding payment cash register at the payment date and determines the customer who corresponds to this customer identification number to be the customer targeted for a recommendation. Further, the customer coupling unit 6 extracts a set of the payment number and the customer identification number as customer information on the customer targeted for a recommendation.

More specifically, the customer coupling unit 6 refers to the purchase history table 2 and identifies that payment has been made by the customer who corresponds to the membership number C001 in the R1 cash register with the payment number P0001 at 11:01:00 on Dec. 1, 2016. Next, the customer coupling unit 6 refers to the flow line history table 5 and specifies the customer identification number that corresponds to the condition that the product area is the R1 cash register and the flow line date is a recent record which is before 11:01:00 on Dec. 1, 2016. In the example shown in FIG. 6, the customer identification number CL001 that corresponds to this condition is specified. Further, the customer coupling unit 6 determines the customer whose customer identification number is CL001 as the customer targeted for a recommendation. Then the customer coupling unit 6 extracts the payment number P0001 and the customer identification number CL001 as the customer information of the customer targeted for a recommendation. In this example, a payment number is used in place of the membership number in consideration of a customer who does not have a membership number.

The customer coupling unit 6 outputs the customer identification number of the extracted customer information to the exclusion area extraction unit 7, and outputs the payment number to the product extraction unit 8. That is, in the example shown in FIG. 6, the customer coupling unit 6 outputs the customer identification number CL001 to the exclusion area extraction unit 7 and outputs the payment number P0001 to the product extraction unit 8.

The exclusion area extraction unit 7 extracts the product area that corresponds to the received customer identification number from the flow line history table 5. Further, the exclusion area extraction unit 7 stores an area in the extracted product area in which the customer who corresponds to the customer identification number has stayed for more than a predetermined staying time in the exclusion area target table 13A as the exclusion area.

More specifically, the exclusion area extraction unit 7 extracts the flow line history that corresponds to the customer identification number CL001 from the flow line history table 5. In the example shown in FIG. 6, the flow line history of the flow line numbers L0001-L0004 is extracted. Next, the exclusion area extraction unit 7 calculates the number of seconds between consecutive data pieces. That is, the exclusion area extraction unit 7 calculates that the customer who corresponds to CL001 has stayed in the entrance area for 10 seconds, stayed in the vegetable area for one second, and stayed in the bread area for 49 seconds. Next, the exclusion area extraction unit 7 extracts the area in which the customer has stayed for more than the predetermined staying time from the calculated number of seconds, and specifies this area to be the exclusion area. In this example, it is assumed that the predetermined staying time is set to five seconds. In the example shown in FIG. 6, the entrance area and the bread area are specified to be the exclusion areas. Then the exclusion area extraction unit 7 stores the entrance area and the bread area in the exclusion area target table 13A as the exclusion areas.

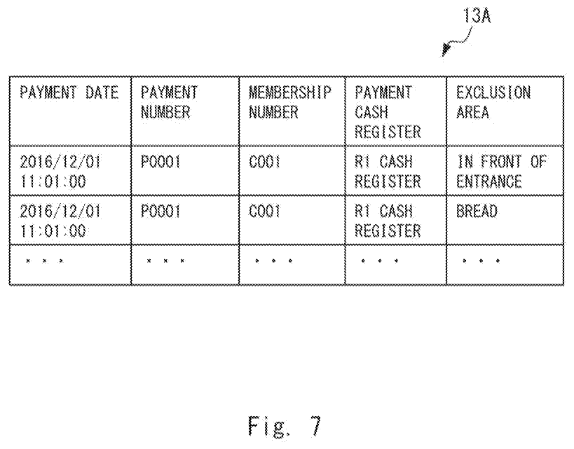

With reference now to FIG. 7, a specific example of the exclusion area target table 13A will be explained. The exclusion area target table 13A stores, besides the exclusion area, payment information that corresponds to the exclusion area. In the example shown in FIG. 7, the exclusion area target table 13A stores the payment date, the payment number, the membership number, the payment cash register, and the exclusion area. The data of the payment date, the payment number, the membership number, and the payment cash register is extracted from the purchase history table 2 and stored in the exclusion area target table 13A.

Referring once again to FIG. 3, descriptions will be continued. The product extraction unit 8 extracts the payment information that corresponds to the received payment number from the purchase history table 2. Further, the product extraction unit 8 stores the extracted payment information in the purchased product target table 12A.

More specifically, the product extraction unit 8 extracts the payment information of the payment number P0001 from the purchase history table 2. In the example shown in FIG. 4, the payment information on the details 01 and 02 of the payment number P0001 is extracted. Next, the product extraction unit 8 stores the extracted payment information on the details 01 and 02 of the payment number P0001 in the purchased product target table 12A.

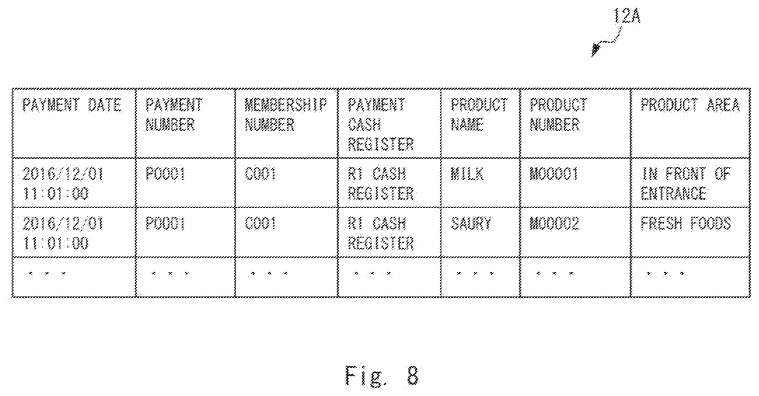

With reference now to FIG. 8, a specific example of the purchased product target table 12A will be explained. In the example shown in FIG. 8, the purchased product target table 12A stores data of the payment date, the payment number, the membership number, the payment cash register, the product name, the product number, and the product area. The data of the payment date, the payment number, the membership number, the payment cash register, the product name, the product number, and the product area is extracted from the purchase history table 2 and stored in the purchased product target table 12A.

Referring once again to FIG. 3, descriptions will be continued. The extraction unit 14A extracts the data pieces that match the product stored in the purchased product target table 12A from the recommendation table 11A. Further, the extraction unit 14A excludes data in which the recommendation product area matches the exclusion area stored in the exclusion area target table 13A from among the data pieces extracted from the recommendation table 11A. That is, the extraction unit 14A extracts the data in which the recommendation product area does not match the exclusion area stored in the exclusion area target table 13A from among the data pieces extracted from the recommendation table 11A. Then the extraction unit 14A stores the data in which the recommendation product area does not match the exclusion area in the distribution target product table 15.

More specifically, the extraction unit 14A extracts data that matches milk and saury stored in the purchased product target table 12A from the recommendation table 11A. In the example shown in FIG. 5, data of sliced bread, dry-cell battery, and beer, which are products to be recommended in view of the prerequisite purchase product: milk, and data of cigarette, which is a product to be recommended in view of the prerequisite purchase product: saury, are extracted. That is, the data of recommendation product numbers M00010, M00020, M00003, and M00004 is extracted. Next, the extraction unit 14A extracts the data in which the recommendation product area does not match the bread area and the entrance area from the data that matches milk and the data that matches saury. In the example shown in FIG. 5, data of the recommendation product numbers M00020, M00003, and M00004 is extracted. Then the extraction unit 14A stores data of the recommendation product numbers M00020, M00003, and M00004 in the distribution target product table 15.

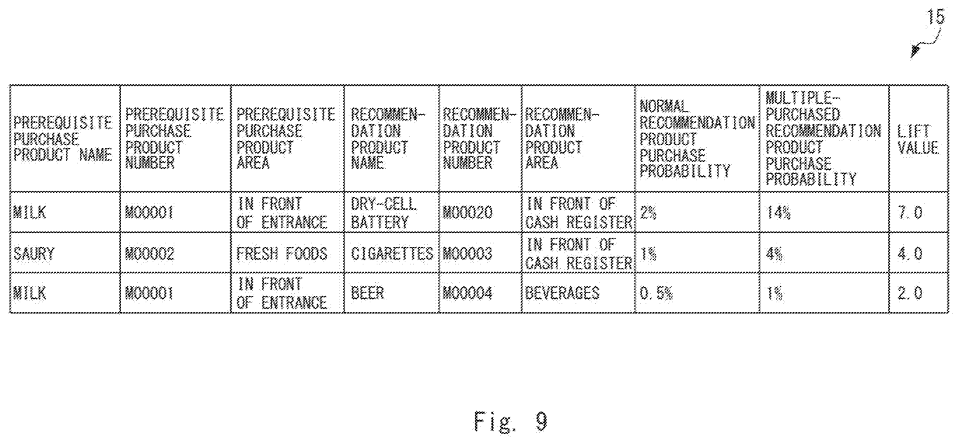

With reference now to FIG. 9, a specific example of the distribution target product table 15 will be explained. In the example shown in FIG. 9, the distribution target product table 15 stores the prerequisite purchase product name, the prerequisite purchase product number, the prerequisite purchase product area, the recommendation product name, the recommendation product number, the recommendation product area, the normal recommendation product purchase probability, the multiple-purchased recommendation product purchase probability, and the lift value, similar to the recommendation table 11A. The distribution target product table 15 further stores data of the recommendation product numbers M00020, M00003, and M00004 among the data stored in the recommendation table 11A. That is, the distribution target product table 15 stores data whose recommendation product names are a dry-cell battery, cigarettes, and beer.

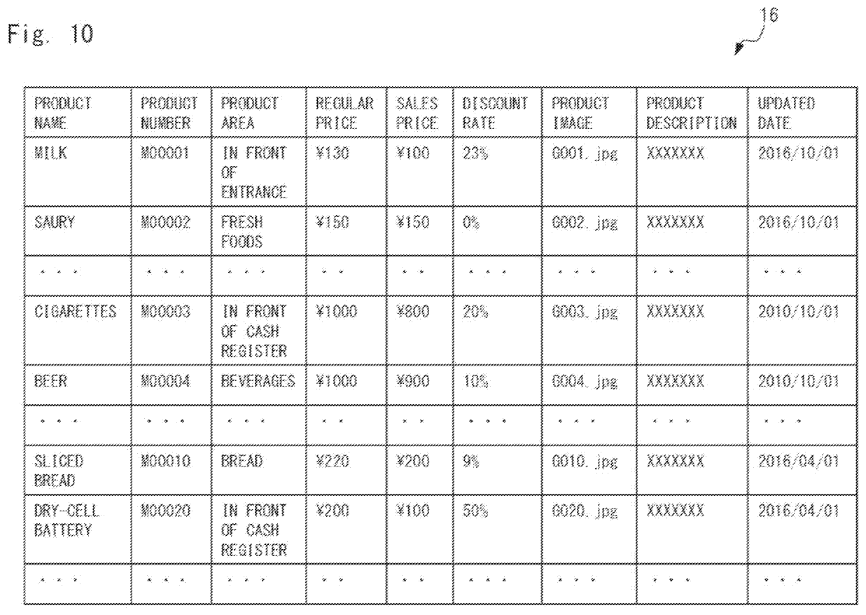

Referring next to FIG. 10, a specific example of the product information master table 16 will be explained. The product information master table 16 stores product information regarding products. The information stored in the product information master table 16 is used when information is distributed to the distribution destination. In the example shown in FIG. 10, the product information master table 16 stores a product name, a product number, a product area, a regular price, a sales price, a discount rate, a product image, product description, and an updated date.

Referring once again to FIG. 3, descriptions will be continued. The distribution unit 17 extracts data pieces whose number corresponds to the number of products to be recommended from the distribution target product table 15 in a descending order of the priority such as the lift value. The number of products to be recommended can be set to, for example, three. The distribution unit 17 further extracts the product information that is necessary for the distribution regarding the extracted data from the product information master table 16. Further, the distribution unit 17 generates distribution information from the product information extracted from the product information master table 16. Then the distribution unit 17 distributes the distribution information to the distribution destination.

More specifically, the distribution unit 17 extracts data of three cases of the recommendation product numbers M00020, M00003, and M00004 in this order from the distribution target product table 15. It is assumed that the number of products to be recommended is set to three. Next, the distribution unit 17 extracts product information that is necessary for the distribution regarding the product numbers M00020, M00003, and M00004 from the product information master table 16. The distribution unit 17 extracts, for example, a product name, a regular price, a sales price, a discount rate, a product image, and a product area as the product information regarding the product numbers M00020, M00003, and M00004. Next, the distribution unit 17 generates distribution information from the extracted product information. Then the distribution unit 17 distributes the distribution information to the distribution destination. The distribution destination is digital signage, a POS cash register, a mail, an application or the like. The information is distributed only to a customer who is a member by mail and application.

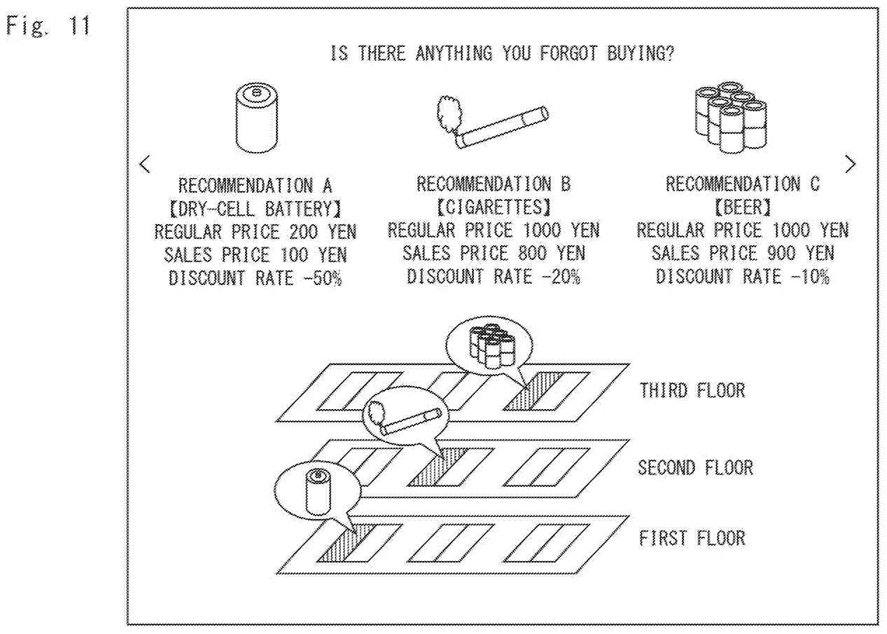

Referring next to FIG. 11, a specific example of the distribution information to be distributed to the distribution destination will be explained. The distribution unit 17 generates, for example, a screen image shown in FIG. 11 and distributes this screen image to the distribution destination. In the example shown in FIG. 11, a dry-cell battery, which is a product that corresponds to the recommendation product number M00020, is displayed as a recommendation product A. Further, the product image, the regular price 200 yen, the sales price 100 yen, and the discount rate −50% of the dry-cell battery are also displayed.

Further, a cigarette, which is a product that corresponds to the recommendation product number M00003, is displayed as a recommendation product B. Further, the product image, the regular price 1000 yen, the sales price 800 yen, and the discount rate −20% of the cigarette are also displayed.

Further, beer, which is a product that corresponds to the recommendation product number M00004, is displayed as a recommendation product C. Further, the product image, the regular price 1000 yen, the sales price 900 yen, and the discount rate −10% of the beer are also displayed.

Further, in the example shown in FIG. 11, the sentence “Is there anything you forgot buying?” is displayed. Further, the positions of the product areas of the respective products are also displayed along with the product images of the respective products. Further, when the recommendation products cannot be displayed in one screen, the customer can view recommendation products that have not been displayed by clicking “<” or “>”.

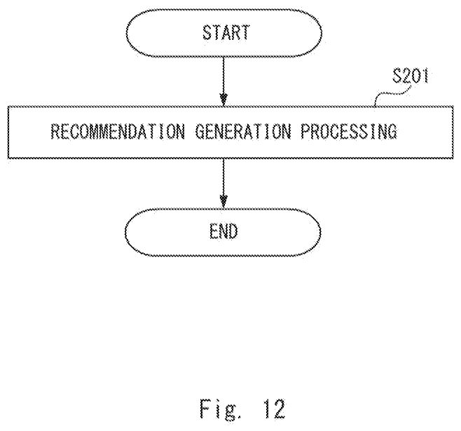

Referring next to a flowchart shown in FIG. 12, recommendation table generation processing of the information processing system 100A will be explained. The recommendation table generation processing is performed by batch processing at regular timings. The unit of the regular timing may be any one of year, month, week, day, and time.

The information processing system 100A performs recommendation generation processing (Step S201). More specifically, the information processing system 100A performs the processing performed by the recommendation generation unit 3 described above as the recommendation generation processing.

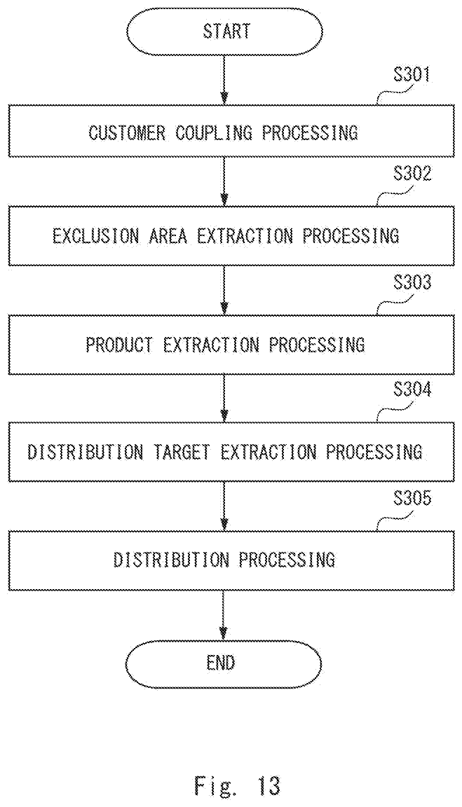

Referring next to a flowchart shown in FIG. 13, recommendation product distribution processing of the information processing system 100A will be explained. The recommendation product distribution processing is performed by real-time processing at the time of making the payment by a POS terminal.

First, the information processing system 100A performs customer coupling processing (Step S301). More specifically, the information processing system 100A performs processing performed by the customer coupling unit 6 described above as the customer coupling processing.

Next, the information processing system 100A performs exclusion area extraction processing (Step S302). More specifically, the information processing system 100A performs processing performed by the exclusion area extraction unit 7 described above as the exclusion area extraction processing.

Next, the information processing system 100A performs product extraction processing (Step S303). More specifically, the information processing system 100A performs the processing performed by the product extraction unit 8 described above as the product extraction processing.

Next, the information processing system 100A performs distribution target extraction processing (Step S304). More specifically, the information processing system 100A performs the processing performed by the extraction unit 14A described above as the distribution target extraction processing.

Next, the information processing system 100A performs distribution processing (Step S305). More specifically, the information processing system 100A performs processing performed by the distribution unit 17 described above as the distribution processing.

As described above, in the information processing system 100A according to the second example embodiment of the present disclosure, the extraction unit 14A is configured to store the products to be recommended for distribution in the distribution target product table 15. Therefore, in the information processing system 100A, by using the products to be recommended for distribution stored in the distribution target product table 15, it is possible to notify, after making a payment, the customer of only those recommended products that the customer was not aware of at the time of making the payment.

Further, in the information processing system 100A, the distribution unit 17 is configured to extract a predetermined number of products to be recommended for distribution from the distribution target product table 15 in a descending order of the priority. Further, in the information processing system 100A, the distribution unit 17 is configured to extract the product information regarding the predetermined number of extracted products to be recommended for distribution from the product information master table 16 to generate distribution information. Further, in the information processing system 100A, the distribution unit 17 is configured to distribute the generated distribution information to the distribution destination. Accordingly, in the information processing system 100A, the predetermined number of products to be recommended for distribution can be distributed to the distribution destination along with the product information in a descending order of the priority.

Further, in the information processing system 100A, the recommendation generation unit 3 is configured to calculate the priority for each of combination of products included in the purchase history table 2. Further, in the information processing system 100A, the recommendation generation unit 3 is configured to store a combination of products in the recommendation table 11A as the purchase products and the products to be recommended in view of the purchase products. Further, in the information processing system 100A, the recommendation generation unit 3 is configured to store the priority regarding a combination of the purchase products and the products to be recommended in view of the purchase products in the recommendation table 11A. Further, in the information processing system 100A, the recommendation generation unit 3 is configured to store the product areas to which the recommendation products belong in the recommendation table 11A. Accordingly, in the information processing system 100A, the recommendation table 11A that stores the purchase products, the products to be recommended in view of the purchase products, the product areas to which the recommendation products belong, and the priority are stored can be generated.

Further, in the information processing system 100A, the customer coupling unit 6 is configured to specify the customer identification number of the customer who has stayed in the payment cash register at the payment date by referring to the purchase history table 2 and the flow line history table 5. Further, in the information processing system 100A, the customer coupling unit 6 is configured to determine the customer who corresponds to the specified customer identification number to be the customer targeted for a recommendation. Further, in the information processing system 100A, the customer coupling unit 6 is configured to extract a set of the payment number and the customer identification number as the customer information on the determined customer targeted for a recommendation. Accordingly, in the information processing system 100A, it is possible to determine the customer targeted for a recommendation based on the purchase history and the flow line history. Further, in the information processing system 100A, it is possible to extract the information on the customer targeted for a recommendation.

Further, in the information processing system 100A, the exclusion area extraction unit 7 is configured to extract the flow line history that corresponds to the customer identification number of the customer targeted for a recommendation from the flow line history table 5. Further, in the information processing system 100A, the exclusion area extraction unit 7 is configured to store an area where the customer targeted for a recommendation has stayed for more than the predetermined staying time among the product areas in the extracted flow line history in the exclusion area target table 13A as the exclusion area. Accordingly, in the information processing system 100A, it is possible to store the product area already viewed by the customer in the exclusion area target table 13A as the exclusion area.

Further, in the information processing system 100A, the product extraction unit 8 is configured to extract the payment information that corresponds to the payment number of the customer targeted for a recommendation from the purchase history table 2. Further, in the information processing system 100A, the product extraction unit 8 is configured to store the extracted payment information in the purchased product target table 12A. Accordingly, in the information processing system 100A, the payment information on the customer targeted for a recommendation can be stored in the purchased product target table 12A.

Further, in the information processing system 100A, the POS terminal 1 is configured to store the payment information in the purchase history table 2 when the product has been purchased. Further, in the information processing system 100A, the flow line generation terminal 4 is configured to generate the flow line history of the customer and store it in the flow line history table 5. Accordingly, in the information processing system 100A, it is possible to recommend products in product areas in a real shop that have not yet been viewed by the customer.

### Third Example Embodiment

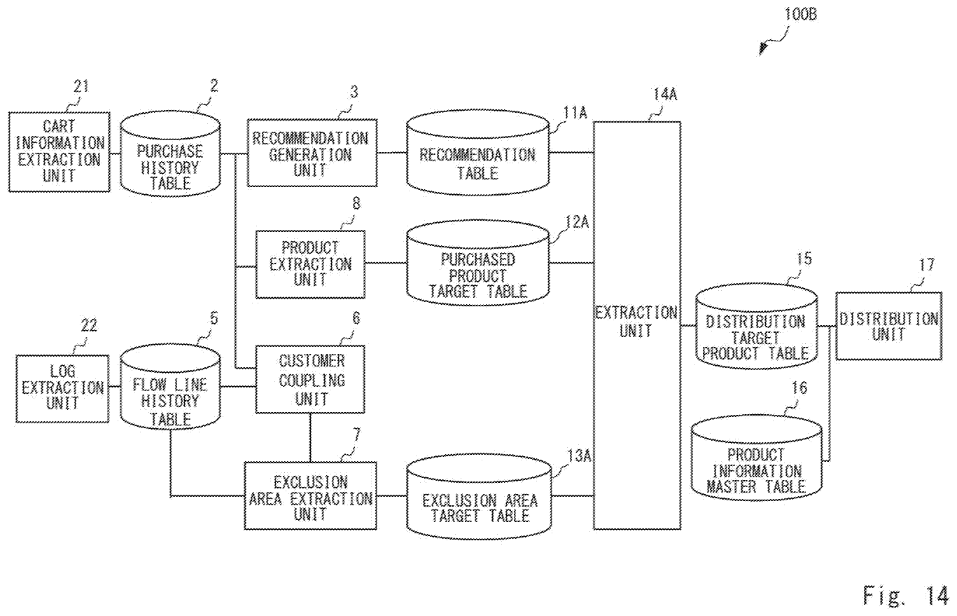

Referring next to a block diagram shown in FIG. 14, a configuration example of an information processing system 100B according to a third example embodiment of the present disclosure will be explained. The information processing system 100B according to the third example embodiment of the present disclosure is a modified example of the information processing system 100A according to the second example embodiment. The information processing system 100B includes a cart information extraction unit 21, a purchase history table 2, a recommendation generation unit 3, a log extraction unit 22, a flow line history table 5, a customer coupling unit 6, an exclusion area extraction unit 7, a product extraction unit 8, a recommendation table 11A, a purchased product target table 12A, an exclusion area target table 13A, an extraction unit 14A, a distribution target product table 15, a product information master table 16, and a distribution unit 17.

The cart information extraction unit 21 extracts product purchase shopping cart information in an Electronic Commerce (EC) site. Further, the cart information extraction unit 21 stores the extracted shopping cart information in the purchase history table 2 as the payment information. It is assumed that the product area stored in the purchase history table 2 of the information processing system 100B is a category of the purchased product. In a similar way, the product area stored in the recommendation table 11A, the purchased product target table 12A, the distribution target product table 15, and the product information master table 16 of the information processing system 100B is a product category.

The log extraction unit 22 extracts an access log of a browsing page. Further, the log extraction unit 22 stores the access log of the browsing page that has been extracted in the flow line history table 5 as the flow line history. The product area stored in the flow line history table 5 of the information processing system 100B is a product category of a browsing page. In a similar way, the product area stored in the exclusion area target table 13A of the information processing system 100B is a product category of a browsing page.

As described above, in the information processing system 100B according to the third example embodiment of the present disclosure, the cart information extraction unit 21 is configured to extract the product purchase shopping cart information in the EC site. Further, in the information processing system 100B, the cart information extraction unit 21 is configured to store the extracted shopping cart information in the purchase history table 2 as the payment information. Further, in the information processing system 100B, the log extraction unit 22 is configured to extract the access log of the browsing page. Further, in the information processing system 100B, the log extraction unit 22 is configured to store the access log of the browsing page that has been extracted in the flow line history table 5 as the flow line history. Accordingly, in the information processing system 100B, it is possible to recommend products that are in product areas in the EC site that have not yet been viewed by the customer.

The processing performed by the information processing system described in the aforementioned first to third example embodiments may be achieved by a computer system including an Application Specific Integrated Circuit (ASIC), a Digital Signal Processor (DSP), a Micro Processing Unit (MPU), or a Central Processing Unit (CPU) included in the information processing system, or a combination thereof. More specifically, a program including instructions that relate to processing of each function unit in the information processing system described with reference to the block diagram or the flowchart is preferably executed by a computer system.

In the aforementioned examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described with reference to the embodiments, the present disclosure is not limited to the aforementioned embodiments. Various changes that can be understood by those skilled in the art can be made to the configurations and the details of the present disclosure within the scope of the present disclosure.

This application is based upon and claims the benefit of priority from Japanese Patent Application No. 2017-24784, filed on Feb. 14, 2017, the disclosure of which is incorporated herein in its entirety by reference.

### REFERENCE SIGNS LIST

1 POS TERMINAL
2 PURCHASE HISTORY TABLE
3 RECOMMENDATION GENERATION UNIT
4 FLOW LINE GENERATION TERMINAL
5 FLOW LINE HISTORY TABLE
6 CUSTOMER COUPLING UNIT
7 EXCLUSION AREA EXTRACTION UNIT
8 PRODUCT EXTRACTION UNIT
11, 11A RECOMMENDATION TABLE
12, 12A PURCHASED PRODUCT TARGET TABLE
13, 13A EXCLUSION AREA TARGET TABLE
14, 14A EXTRACTION UNIT
15 DISTRIBUTION TARGET PRODUCT TABLE
16 PRODUCT INFORMATION MASTER TABLE
17 DISTRIBUTION UNIT
21 CART INFORMATION EXTRACTION UNIT
22 LOG EXTRACTION UNIT
100, 100A, 100B INFORMATION PROCESSING SYSTEM

What is claimed is:

1. An information processing system comprising:
a recommendation table configured to store a purchase product, products to be recommended in view of the purchase product, and product areas to which the recommendation products belong;
a purchased product target table configured to store a purchased product purchased by a customer targeted for a recommendation;
an exclusion area target table configured to store an area where the customer targeted for a recommendation has stayed for more than a predetermined staying time as an exclusion area; and
extraction means for extracting the products to be recommended in view of the purchased product as products to be recommended for the customer by referring to the purchased product target table and the recommendation table and extracting products to be recommended for distribution by referring to the recommendation table and the exclusion area target table and excluding a recommendation product that belongs to the product area that matches the exclusion area from the products to be recommended for the customer.

2. The information processing system according to claim 1, further comprising:
a distribution target product table,
wherein the extraction means stores the products to be recommended for distribution that have been extracted in the distribution target product table.

3. The information processing system according to claim 2, further comprising:
a product information master table configured to store product information regarding products; and
distribution means, wherein
the distribution target product table stores the products to be recommended for distribution and priority of each of the products to be recommended for distribution, and
the distribution means extracts a predetermined number of products to be recommended for distribution from the distribution target product table in a descending order of the priority, generates distribution information by extracting product information regarding the predetermined number of extracted products to be recommended for distribution from the product information master table, and distributes the distribution information to a distribution destination.

4. The information processing system according to claim 1, further comprising:
a purchase history table configured to store payment information including a product in each payment; and
recommendation generation means, wherein
the recommendation generation means calculates the priority for each of combination of the products included in the purchase history table, stores the combination of the products in the recommendation table as the purchase product and the products to be recommended in view of the purchase product, stores the priority regarding the combination of the purchase product and the products to be recommended in view of the purchase product in the recommendation table, and stores product areas to which the recommendation products belong in the recommendation table.

5. The information processing system according to claim 4, further comprising:
a flow line history table configured to store a flow line date of a customer, a customer identification number, and a product area as a flow line history; and
customer coupling means, wherein
the purchase history table further stores a payment date, a payment number, and a payment cash register in each payment as the payment information, and
the customer coupling means refers to the purchase history table and the flow line history table to specify a customer identification number of the customer who has stayed in the payment cash register at the payment date, determine a customer who corresponds to the specified customer identification number to be the customer targeted for a recommendation, and extracts a set of payment number and customer identification number as the customer information on the customer targeted for a recommendation.

6. The information processing system according to claim 5, further comprising:
exclusion area extraction means,
wherein the exclusion area extraction means extracts the flow line history that corresponds to a customer identification number of the customer targeted for a recommendation from the flow line history table, and stores an area in which the customer targeted for a recommendation has stayed for more than a predetermined staying time among product areas in the extracted flow line history in the exclusion area target table as an exclusion area.

7. The information processing system according to claim 5 or 6, claim 5, further comprising:
product extraction means,
wherein the product extraction means extracts the payment information that corresponds to a payment number of the customer targeted for a recommendation from the purchase history table, and stores the extracted payment information in the purchased product target table.

8. The information processing system according to claim 5, further comprising:
a Point Of Sales (POS) terminal; and
a flow line generation terminal, wherein
the POS terminal stores the payment information in the purchase history table when a product is purchased, and
the flow line generation terminal generates the flow line history of a customer and stores the generated flow line history in the flow line history table.

9. The information processing system according to claim 5, further comprising:
cart information extraction means; and
log extraction means; wherein
the cart information extraction means extracts product purchase shopping cart information in an Electronic Commerce (EC) site, and stores the extracted shopping cart information in the purchase history table as the payment information, and
the log extraction means extracts an access log of a browsing page and stores the access log of the browsing page that has been extracted in the flow line history table as the flow line history.

10. An information processing method comprising:
extracting a purchased product purchased by a customer targeted for a recommendation from a purchased product target table configured to store the purchased product;
extracting products to be recommended in view of the purchased product as products to be recommended for the customer by referring to a recommendation table configured to store a combination of the purchase product, products to be recommended in view of the purchase product, and product areas to which the recommendation products belong;
extracting an exclusion area from an exclusion area target table configured to store an area where the customer targeted for a recommendation has stayed for more than a predetermined staying time as the exclusion area;
extracting the product area that matches the exclusion area by referring to the recommendation table; and
extracting products to be recommended for distribution by excluding a recommendation product that belongs to a product area that matches the exclusion area from the products to be recommended for the customer.
